(19) United States
(12) Patent Application Publication
(10) Pub. No.: US 2024/0060788 A1
(43) Pub. Date: Feb. 22, 2024

(54) MAP SIMULATION SERVICES

(71) Applicant: GM Cruise Holdings LLC, San Francisco, CA (US)

(72) Inventors: Yosser D'Avanzo, Brandon, FL (US); Irfan Lone, Miliptas, CA (US); Brian Donohue, San Francisco, CA (US); Jeffrey Li, San Francisco, CA (US); Jonathon Gillespie, San Francisco, CA (US); Kavya Sambana, Castro Valley, CA (US)

(73) Assignee: GM Cruise Holdings LLC, San Francisco, CA (US)

(21) Appl. No.: 17/889,605

(22) Filed: Aug. 17, 2022

(51) Int. Cl. G01C 21/34; G01C 21/30; G01C 21/36

(52) U.S. Cl. CPC G01C 21/3476; G01C 21/30; G01C 21/3626

(57) ABSTRACT

Systems and methods for map simulation testing are provided. A method includes receiving, by a computer-implemented system, information associated with an operational design domain (ODD); generating, by the computer-implemented system based at least in part on the information associated with the ODD, a plurality of map test cases for a map representative of a geographical area in the ODD, where each map test case of the plurality of map test cases includes one of a plurality of paths in the geographical area; evaluating a vehicle planning process in navigating through one or more of the plurality of paths corresponding to one or more of the plurality of map test cases; and determining a metric for the map based on the evaluating.

### BACKGROUND

### 1. Technical Field

The present disclosure generally relates to autonomous vehicle and, more specifically, to map simulation services (e.g., for testing map data).

### 2. Introduction

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating the vehicles in making driving decisions. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a simulation environment for autonomous driving in which one or more map simulation test services may be implemented, according to some examples of the present disclosure;

FIG. 2 illustrates a map simulation test scheme, according to some examples of the present disclosure;

FIG. 3 illustrates a map simulation test scheme, according to some examples of the present disclosure;

FIG. 4A illustrates a map simulation test scheme, according to some examples of the present disclosure;

FIG. 4B illustrates a map simulation test result, according to some examples of the present disclosure;

FIG. 4C illustrates a map simulation test result, according to some examples of the present disclosure;

FIG. 5 illustrates a map simulation test process, according to some examples of the present disclosure;

FIG. 6 illustrates a map simulation test process, according to some examples of the present disclosure;

FIG. 7 illustrates an example system environment that may be used to facilitate autonomous vehicle (AV) dispatch and operations, according to some aspects of the disclosed technology; and

FIG. 8 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Autonomous vehicles (AVs) can provide many benefits. For instance, AVs may have the potential to transform urban living by offering opportunity for efficient, accessible and affordable transportation. An AV may be equipped with various sensors to sense an environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. Subsequently, instructions can be sent to a controller to control the AV (e.g., for steering, accelerating, decelerating, braking, etc.) according to the planned path.

The operations of perception, prediction, planning, and control at an AV may be implemented using a combination of hardware and software components. For instance, an AV stack or AV compute process performing the perception, prediction, planning, and control may be implemented as software code or firmware code. The AV stack or AV compute process (the software and/or firmware code) may be executed on processor(s) (e.g., general processors, central processors (CPUs), graphical processors (GPUs), digital signal processors (DSPs), ASIC, etc.) and/or any other hardware processing components on the AV. Additionally, the AV stack or AV compute process may communicate with various hardware components (e.g., on-board sensors and control system of the AV) and/or with an AV infrastructure over a network.

Training and testing AVs in the physical world can be challenging. For instance, to provide good testing coverage, an AV may be trained and tested to respond to various driving scenarios (e.g., millions of physical road test scenarios) before it can be deployed in a real-life roadway system. As such, it may be costly and time-consuming to train and test AVs on physical roads. Furthermore, there may be test cases that are difficult to create or too dangerous to cover in the physical world. Accordingly, it may be desirable to train and validate AVs in a simulation environment.

A simulator may simulate (or mimic) real-world conditions (e.g., roads, lanes, buildings, obstacles, other traffic participants, trees, lighting conditions, weather conditions, etc.) so that an AV may be tested in a virtual environment that is close to a real physical world. Testing AVs in a simulator can be more efficient and allow for creation of specific traffic scenarios. To that end, the AV compute process implementing the perception, prediction, planning, and control algorithms can be developed, validated, and fine-tuned in a simulation environment. More specifically, the AV compute process may be executed in an AV simulator (simulating various traffic scenarios), and the AV simulator may compute metrics related to AV driving decisions, AV response time, etc. to determine the performance of an AV to be deployed with the AV compute process.

In some examples, it may be desirable to test the quality and/or accuracy of a map that represents a certain geographical area. For instance, the planning process at an AV may determine a route and/or a trajectory for the AV based on map data. Map data can be collected and/or generated in a wide variety of ways. In one example, a vehicle equipped with sensors, such as light detection and ranging (LIDAR) sensors and camera sensors, may be driven around a city to collect data about the roads and surroundings of the city. The collected sensor data may be processed. For instance, the LIDAR sensors may send out laser beam(s) (e.g., pulses of light) to surroundings of the vehicle, and the distance and dimensions of road features can be determined based on the amount of time it takes for the laser beam to bounce back to the sensors. Subsequently, road features, such as roads, lanes, road markings, intersections, etc., may be identified from the collected and/or processed sensor data. The identified features can be categorized and/or labels can be applied to the identified features. Map data or map products can then be generated based on the processed sensor data and associated labels and subsequently release for use by AVs for planning. The generation and/or update of map data may be an ongoing process as roads and surroundings may change over time due to various reasons, such as weather, time of the day, environment conditions, road works, road updates, temporary road closures, traffic light and/or traffic sign removals and/or additions, etc. Accordingly, it may not be sufficient to test AV planning process in simulation alone but also the quality and accuracy of map data prior to a map release. Furthermore, it may be beneficial to test the compatibility between a new or updated map and an AV compute process prior to releasing the new or updated map.

The present disclosure provides mechanisms for testing map data in simulation. In contrast to conventional simulation testing in which an AV compute process (e.g., perception, prediction, planning, and/or control) may be tested against a certain map for AV validation, the present disclosure provides map simulation test services for validating and/or qualifying the qualities and/or accuracies of a map across a map design domain. For instance, the map may be for a geographical area within an operational design domain (ODD).

Operational design domain (ODD) is a specific domain in which an autonomous driving system is designed to operate. Some examples of ODD factors may include, but is not limited to, types of roadways, ranges of speed, weather, time of the day, and environmental conditions. As an example, instance, an AV may only function on clear days, on highways, but not on one-way streets. As another example, an AV may not make a left-turn across traffic during a certain time period of the day. As a further example, an AV may not drive through a certain area in the ODD. The area to be avoided may be for long-term avoidance (e.g., more than a day) or short-term avoidance (e.g., during certain hours of the day). In some instances, the area to be avoided may be due to the shape of the ODD. In some examples, the ODD factors may be based on local traffic laws.

According to an aspect of the present disclosure, a computer-implemented system may implement a map simulation test service. For instance, the computer-implemented system may receive information associated with an ODD in which a vehicle (e.g., an AV) is designed to operate. Based on the ODD information, the computer-implemented system may generate a plurality of map test cases for a map representative of a geographical area in the ODD. Each map test case of the plurality of map test cases may include one of a plurality of paths in the geographical area. The computer-implemented system may evaluate a vehicle planning process (e.g., an AV planning stack) in navigating through one or more of the plurality of paths corresponding to one or more of the plurality of map test cases. Subsequently, the computer-implemented system may determine a metric for the map based on the evaluation. In some aspects, the map metric may be a pass or fail indication. In other aspects, the metric may provide a more detail view into the reasons for the failures and/or associated failure statistics.

In some aspects, the ODD information may include an indication of one or more avoidance areas (e.g., which may be for short-term and/or long-term avoidance) within the geographical area. Accordingly, as part of generating the plurality of map test cases, the computer-implemented system may refrain from selecting a path that traverses into the one or more avoidance areas. Stated differently, the computer-implemented system may determine the plurality of paths in a portion of the geographical area outside of the one or more avoid areas. In some aspects, the computer-implemented system may receive the ODD information in real-time, for example, based on a real-time road update about a certain road closure, road and/or lane changes, traffic light and/or traffic sign removals and/or additions, etc.

To generate the map test cases, the computer-implemented system may iterate through a plurality of routable traffic links in the geographical area to determine the plurality of paths. The traffic links can be at any suitable granularity, for example, a street, a lane, a group of streets, or a group of lanes. As part of iterating through the traffic links, the computer-implemented system may filter out one or more un-routable traffic links in the geographical area. In some instances, the un-routable traffic links may be within the one or more avoidance areas indicated by the ODD information. In some instances, the ODD information may include a blacklist specifying the particular un-routable traffic links in the ODD. In some aspects, the computer-implemented system may represent the traffic links in the geographical area as a plurality of graphs. The computer-implemented system may partition a traffic link into multiple connected traffic link segments represented by connected subgraphs. For instance, as part of generating the map test cases, the computer-implemented system may determine a first path of the plurality of paths by selecting one or more connected subgraphs from the plurality of subgraphs. Further, as part of determining the first path, the computer-implemented system may take into account a subgraph (or traffic link segment) before the first path and a subgraph (or traffic link segment) after the first path. The computer-implemented system may also determine the first path such that the vehicle may start and/or stop at a suitable location (e.g., avoiding an intersection) for the testing.

In some aspects, the map simulation test service may be configurable. For instance, a map test can be configured to account for a certain capability of the vehicle planning process, certain traffic rules and/or laws in the ODD, and/or a certain target performance associated with the vehicle test process.

A further aspect of the present disclosure may provide mechanisms for scalable map simulation tests. For instance, a computer-implemented system may receive a map test configuration. To provide scalability of the map testing, the map test configuration may include an indication of a geofence (e.g., a set of virtual boundaries enclosing a certain area) within a geographical area of an ODD, a number of test cases, and/or a number of traffic links (e.g., streets and/or lanes) to cover for testing. The computer-implemented system may generate a plurality of map test cases for a map representative of the geographical area based on the map test configuration. Each map test case of the plurality of map test cases may include one of a plurality of paths within the geofence in the geographical area. As similarly discussed above, the computer-implemented system can iterate through the traffic links (e.g., all combinations) within the geofence to determine the plurality of paths. The computer-implemented system may output a map test object including the plurality of test cases. The number of map test cases and/or the number of traffic links iterated may be as specified by the map test configuration. Depending on the desired test (e.g., whether to test a small area within a city or an entire city) and/or the reason for the testing (e.g., code debug by developers, code integration for release, minor release, and/or major release, etc.), the map test configuration can be configured accordingly so that the computer-implemented system may generate map test cases to satisfy the desired test.

The systems, schemes, and mechanisms described herein can advantageously provide a systematic approach to test the quality and/or the accuracy of a map and including ODD factors as part of map testing. Generating map test cases to cover traffic links in an area with consideration for ODD factors and testing a vehicle planning process against the map test cases in a simulation environment can ensure that a map release or product is compatible with vehicle planning processes designed for operations in the ODD. In other words, the disclosed map simulation test services can avoid or at least minimize disengagement (or incompatibility) between vehicle planning and map data. Further, the scalability of the disclosed map simulation test services may be suitable for vehicle or AV code development, integration, and/or release testing, for example, to detect any update or enhancement to an AV code that may be incompatible with a certain map version.

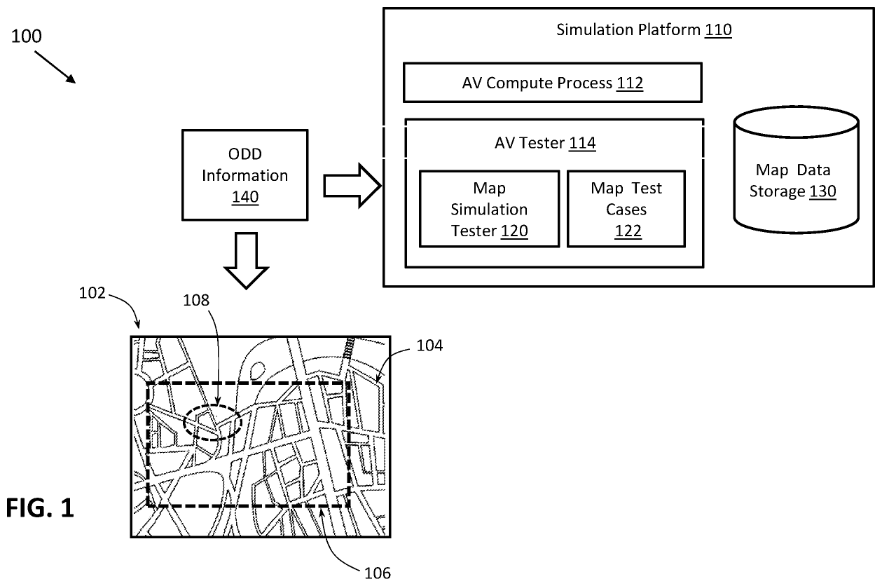

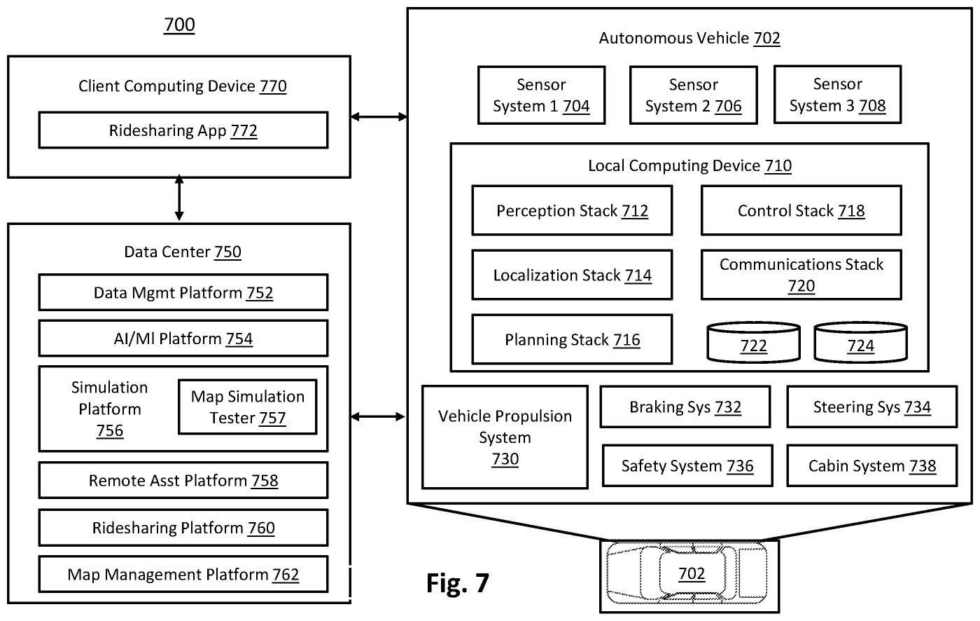

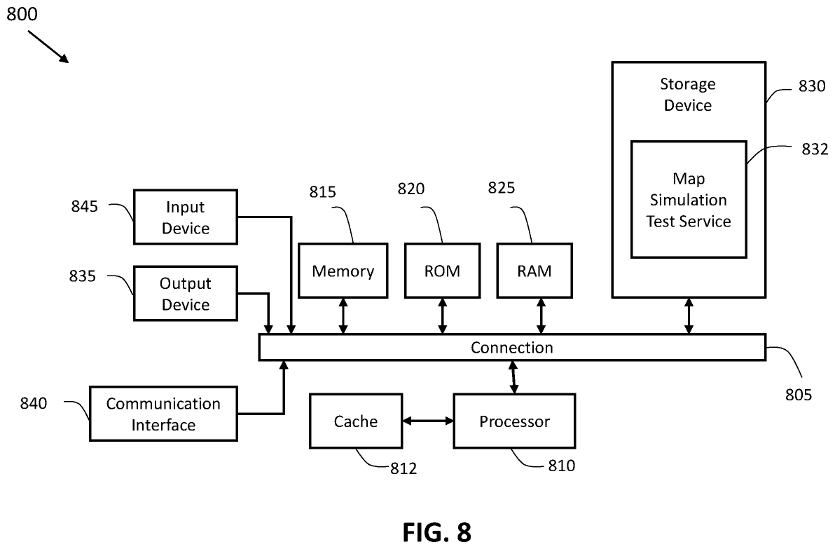

FIG. 1 illustrates a simulation environment 100 for autonomous driving in which one or more map simulation services may be implemented, according to some examples of the present disclosure. The simulation environment 100 may include a simulation platform 110 for testing a map 102 representative of a geographical area. The simulation platform 110 may be any suitable computer-implemented system. In some examples, the simulation platform 110 may be similar to the simulation platform 756 of FIG. 7. In some examples, the simulation platform 110 may be similar to the processor-based system 800 of FIG. 8. In some examples, the simulation platform 110 may utilize cloud services for compute resources, storage resources, network resources, etc. In some examples, the simulation platform 110 may be part of a data center 750 as shown in FIG. 7. In general, the simulation platform 110 may be used for AV code development, code testing, and/or code integration.

In an aspect, an AV compute process (or software stack) 112 may be executed on the simulation platform 110. The AV compute process 112 may include a perception stack, a prediction stack, a planning stack, a control stack, etc. as will be discussed more fully below with reference to FIG. 8. Further, an AV tester 114 (e.g., including testing software, tools, testing simulator, etc.) may be executed on the simulation platform 110. The AV tester 114 may generate test cases 122 for various traffic scenarios (e.g., a scenario 104) and test the AV compute process 112 using the test cases 122. To that end, the AV tester 114 may execute the AV compute process 112 in the test traffic scenarios and measure the performance of the AV compute process 112, for example, in terms of perception, prediction, planning, control, etc., or an overall driving performance. After the AV compute process 112 successfully passes the test cases 122 or traffic scenarios, the AV compute process 112 can be deployed in an AV, which may be a semi-autonomous vehicle or semi-autonomous vehicle. In some examples, the AV may be similar to the AV 702 of FIG. 7.

According to aspects of the present disclosure, the AV tester 114 may include a map simulation tester 120. As shown in FIG. 1, the map simulation tester 120 may receive ODD information 140 (e.g., in real time) about the geographical area in an ODD. As explained above, ODD is the operating conditions under which a given driving automation system or feature thereof is specifically designed to function, including, but not limited to, environmental, geographical, and time-of-day restrictions, and/or the requisite presence or absence of certain traffic or roadway characteristics. In an example, the ODD information 140 can include indication(s) of area(s) within the geographical area to avoid when an AV planning stack is to plan a path for the AV in an area under the ODD. As an example, the map 102 may include representations for traffic links 104 (e.g., roads and/or lanes) in the geographical area, and the ODD information 140 may include an indication of an avoidance area 108 in the geographical area. In some examples, the simulation platform 110 can include a map storage 130 in which map data may be stored. In other examples, the map storage 130 may located at a remote server or cloud storage, for example, provided by a map service, and the simulation platform 110 may request for the map 102 from the map service. In general, the map storage may be similar to the high definition (HD) geospatial database 722 of FIG. 7 discussed below.

As explained above, map information can vary over time due to various reasons, weather, time of the day, environment conditions, road works, road updates, temporary road closures, etc. Accordingly, the map simulation tester 120 may provide map simulation services specifically for testing the quality and/or accuracy of maps (e.g., the map 102).

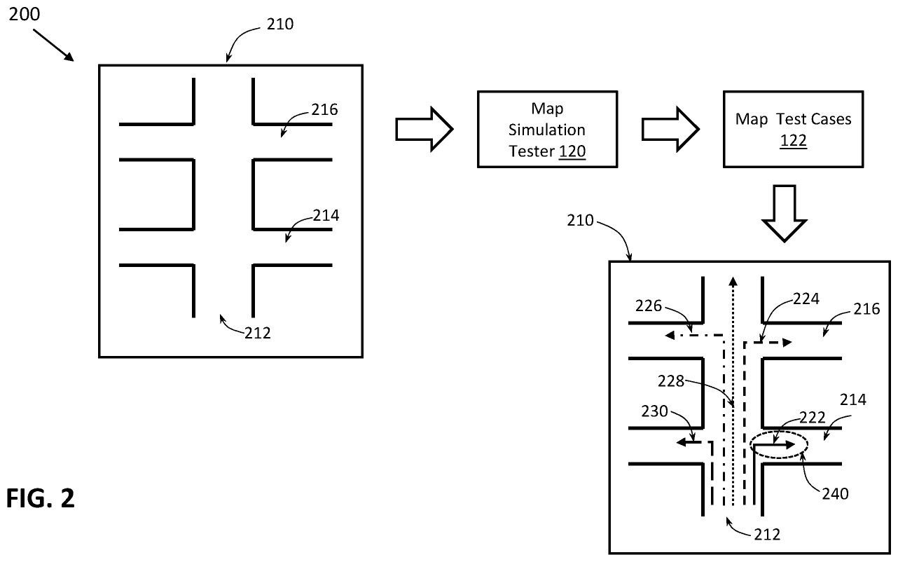

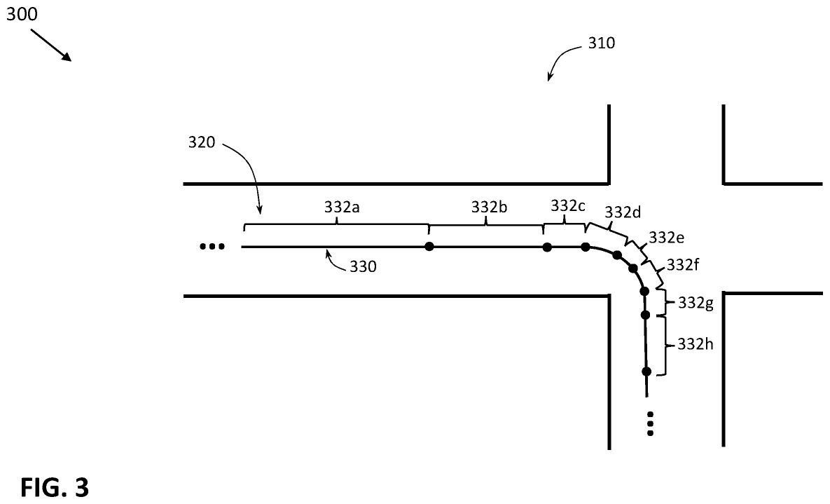

In an aspect, the map simulation tester 120 may generate a plurality of map test cases 122 for the map 102 based on the ODD information. Each map test case 122 of the plurality of map test cases 122 may include one of a plurality of paths in the geographical area. Each path may traverse through one or more street and/or lane segments in the geographical area as will be discussed more fully below with reference to FIG. 2. In some aspects, the map simulation tester 120 may generate map test cases 122 for traffic links within a certain sub-area of the geographical area. As shown in FIG. 1, a geofence 106 can be defined for the geographical area. A geofence may be a set of virtual boundaries that define an enclosed area within a geographical area. In some aspects, the map simulation tester 120 may determine the plurality of paths for the map test cases 122 using graph theory techniques as will be discussed more fully below with reference to FIG. 3.

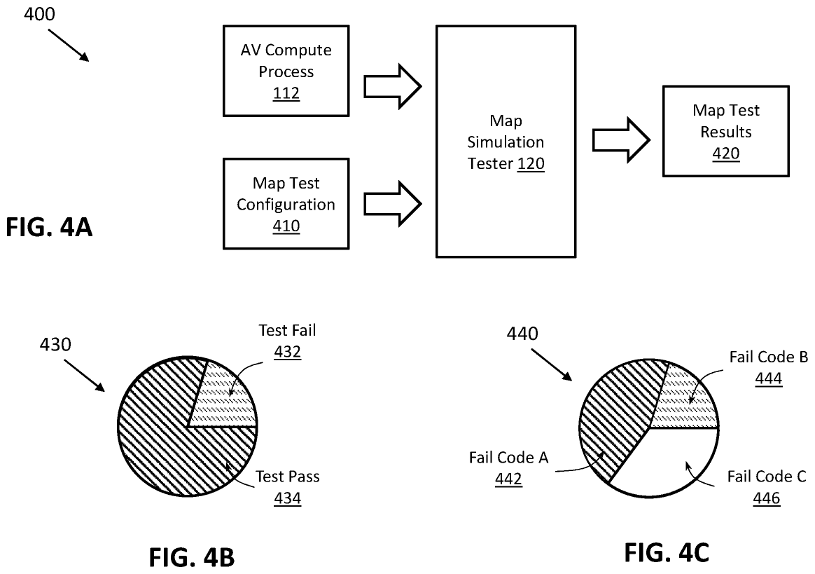

To determine a test metric for the map 102, the map simulation tester 120 may execute the AV compute process 112 (e.g., including at least an AV planning process) in test scenarios corresponding to the map test cases 122 and evaluate the performance of the AV compute process 112. Because the purpose of map testing is to test the quality and/or accuracy of the map 102, the test scenarios may include information relevant to the map and may not include any other traffic participants (e.g., other vehicles, pedestrians, cyclist, etc.). In some instances, such test scenarios may be referred to as “empty scenes” (e.g., two-dimensional empty scenes) and the evaluation may be for the performance of an AV deployed with the AV compute process 112 in navigating through the paths as specified by the respective map test cases. In some aspects, the map simulation tester 120 may determine a passing rate for the map 102 based on a percentage of the map test cases 122 in which the AV compute process 112 successfully navigate through the corresponding paths. The map simulation tester 120 may also determine a failing rate for the map 102 based on a percentage of the map test cases 122 in which the AV compute process 112 fails to navigate through the corresponding paths. In some aspects, the map simulation tester 120 may further analyze the failed test cases 122 to determine the reasons that caused the failures. In general, the map simulation tester 120 may provide the test metric for the map 102 in various forms as will be discussed more fully below with reference to FIG. 4.

FIGS. 2-3 are discussed in relation to FIG. 1 to provide a more detailed view of the generation of the map test case 122. FIG. 2 illustrates a map simulation test scheme 200, according to some examples of the present disclosure. The scheme 200 may be implemented by the map simulation tester 120 of FIG. 1 and/or any suitable computer-implemented system such as the simulation platform 756 of FIG. 7 and/or the processor-based system 800 of FIG. 8. The scheme 200 may generate map test scenarios or test cases (e.g., the map test cases 122) for determining a quality or an accuracy of a map 210.

For simplicity of illustration and discussion, FIG. 2 illustrates the map 210 including one traffic link 212 (e.g., a street or a lane) with two cross traffic links 214 and 216. In general, a map can include any suitable number roads, streets, and/or lanes arranged in any suitable configuration representing an actual physical geographical area. In the scheme 200, the map simulation tester 120 may generate a plurality of map test cases 122 for testing the map 210. Each map test case 122 may include one of a plurality of paths in the geographical area. In an example, the map simulation tester 120 may traverse every routable traffic links (e.g., the traffic links 212, 214, and 216) in the map 210. Stated differently, the map simulation tester 120 may iterate through a plurality of traffic links (e.g., streets and/or lanes) in the geographical area to determine the plurality of paths. In general, the map simulation tester 120 may iterate the traffic links at any suitable granularity, at a level of a street, a lane, a group of streets, a group of lanes, etc., and the iteration may include an exhaustive search through every combination of streets, lanes, groups of streets, and/or groups of lanes.

For the illustrated example map 210, a first map test case 122 may include a path 222 traversing the traffic link 212 and making a right-turn at the cross traffic link 214 as shown by the solid arrow. A second map test case 122 may include a path 224 traversing the traffic link 212, passing the cross traffic link 214, and making a right-turn at the cross traffic link 216 as shown by the dashed arrow. A third map test case 122 may include a path 226 traversing the traffic link 212, passing the cross traffic link 214, and making a left-turn at the cross traffic link 216 as shown by the dashed-dotted arrow. A fourth map test case 122 may include a path 228 traversing the traffic link 212 and passing the cross traffic links 214 and 216 as shown by the dotted arrow. A fifth map test case 122 may include a path 230 traversing the traffic link 212 and making a left-turn at the traffic link 214 as shown by the long-dashed arrow.

In some aspects, the map simulation tester 120 may determine the test cases 122 (or paths such as the paths 222, 224, 226, 228, and 230) based on ODD information such as the ODD information 140 as discussed above with reference to FIG. 1. As an example, the map simulation tester 120 may receive ODD information including an indication of an avoidance area 240 in the area of the map 210 as shown by the dashed oval. As such, as part of iterating through the traffic links 212, 214, and 216 in the area represented by the map 210, the map simulation tester 120 may filter out the traffic link(s) (e.g., un-routable traffic link(s)) in the avoidance area 240. For the example map 210, the map simulation tester 120 may exclude the path 222 (the first map test case discussed above) when generating the map test cases 122.

FIG. 3 illustrates a map simulation test scheme 300, according to some examples of the present disclosure. The scheme 300 may be implemented by the map simulation tester 120 of FIG. 1 and/or any suitable computer-implemented system such as the simulation platform 756 of FIG. 7 and/or the processor-based system 800 of FIG. 8. The scheme 300 can be implemented in conjunction with the scheme 200. In the scheme 300, the map simulation tester 120 may generate map test cases (e.g., the map test cases 122) using graph theory techniques.

In mathematics, graph theory is the study of graphs, which are mathematical structures used to model pairwise relations between objects. A graph in this context is made up of vertices (also called nodes or points) which are connected by edges (also called traffic links or lines). A distinction is made between undirected graphs, where edges link two vertices symmetrically, and directed graphs, where edges traffic link two vertices asymmetrically. Graphs are one of the principal objects of study in discrete mathematics.

In the scheme 300, the map simulation tester 120 may generate map test cases using graph theory. That is, the map simulation tester 120 may represent traffic links (e.g., streets and/or lanes) using graphs. The map simulation tester 120 may further partition a graph representing a traffic link into subgraphs representing traffic link segments. The map simulation tester 120 may generate a map test case covering one or more subgraphs or traffic link segments.

For instance, the map simulation tester 120 may iterate through a plurality of traffic links in the geographical area 310, for example, through an exhaustive search as discussed above with reference to FIG. 2. For simplicity of discussion, FIG. 3 illustrates one traffic link 320 (e.g., a street or a lane) in a geographical area 310. The map simulation tester 120 may represent the traffic link 320 as a graph 330. The map simulation tester 120 may partition the graph 330 (representing the traffic link 320) into a plurality of connected subgraphs 332 (shown as 332a, 332b, 332c, 332d, 332e, 332f, 332g, and 332h) corresponding to segments of the traffic link 320. A node (shown by a black circle) may correspond to the start of one subgraph and an end of an adjacent, connected subgraph adjacent. In some aspects, the map simulation tester 120 may partition the graph 330 uniformly so that each of the connected subgraphs 332 may correspond to traffic link segments of about the same distance. In other aspects, the map simulation tester 120 may partition the graph 330 non-uniformly, for example, with shorter segments for a portion of a traffic link that is more complex for navigation. As shown, the map simulation tester 120 may partition the traffic link 320 at the intersection with shorter segments when a turn is included, where the subgraphs 332c to 332g at the intersection have shorter distances than the subgraphs 332a, 332b, and 332h.

To determine a path in the geographical area 310 for a map test case, the map simulation tester 120 may select one or more connected subgraphs from the plurality of connected subgraphs 332a to 332h. As an example, the map simulation tester 120 may determine a first path including the subgraphs 332a and 332b for a first map test case 122, determine a second path including the subgraphs 332c, 332d, 332e, 332f, and 332g for a second map test case 122, and so on. In some aspects, the map simulation tester 120 may consider an upstream subgraph (e.g., referred to as a prefix) and a downstream subgraph (e.g., referred to as a suffix) when selecting subgraphs for a map test case. For instance, for the second map test case 122, the map simulation tester 120 may select the subgraphs 332c, 332d, 332e, 332f, and 332g (e.g., starting from the subgraph 332c to the 332g) based on the subgraph 332b connecting to the start of the subgraph 332c (the beginning subgraph of the path) and the subgraph 332h connecting to the end of the subgraph 332g (the last subgraph of the path). In some aspects, the map simulation tester 120 may determine a path for a map test case such that the path may start and end at suitable locations, for example, by avoiding to start or end a path in the middle of an intersection. Referring to the example shown in FIG. 3, the map simulation tester 120 may avoid selecting a path that begins with or end with any of the subgraphs 332e and 332f.

FIGS. 4A-4C are discussed in relation to each other and FIG. 1 to illustrate map simulation testing. FIG. 4A illustrates a map simulation test scheme 400, according to some examples of the present disclosure. The scheme 400 may be implemented by the map simulation tester 120 and/or any suitable computer-implemented system such as the simulation platform 756 of FIG. 7 and/or the processor-based system 800 of FIG. 8. The scheme 400 may be used in conjunction with the schemes 200 and 300 discussed above with reference to FIGS. 2 and 3, respectively.

In the scheme 400, the map simulation tester 120 may receive a map test configuration 410 and the AV compute process 112 as inputs and may output map test results 420. The map test configuration 410 may include a variety of information. In some examples, the map test configuration 410 may include an indication of a map (e.g., the maps 102 and/or 210) in a certain ODD for map testing. The map test configuration 410 may further indicate map versioning information associated with the map under test. Additionally or alternatively, the map test configuration 410 may include an indication of a geofence (e.g., the geofence 106) in which map test cases (e.g., the map test cases 122) are to cover traffic links (e.g., the traffic links 212, 214, 216) within the geofence. Additionally or alternatively, the map test configuration 410 may include an indication of a number of map test cases to generate for testing the map. Additionally or alternatively, the map test configuration 410 may include an indication of a number of traffic links (or a percentage of traffic links) or a percentage of traffic links to be covered for testing the map. The map simulation tester 120 may generate map test cases in accordance with the map test configuration 410. In this way, the map test configuration 410 can support scalability for map testing.

As an example, the map test configuration 410 may include an indication of a geofence, 5000 map test cases, and 200 traffic links. Accordingly, the map simulation tester 120 may generate 5000 map test cases covering 200 traffic links in an area bounded by the geofence, where each map test cases may include one of a plurality of paths along one or more traffic links or traffic link segments in the area. In some instances, the map simulation tester 120 may further receive ODD information (e.g., the ODD information 140) indicating one or more avoidance areas (e.g., a blacklist including area(s), street(s), and/or lane(s) to avoid). Accordingly, the map simulation tester 120 may generate the map test cases with paths excluding (or filtering out) any traffic links or traffic link segments within the one or more avoidance areas. After generating the map test cases, the map simulation tester 120 may execute the AV compute process 112 (e.g., including an AV perception stack, an AV prediction stack, and an AV planning stack or an AV planning stack alone) in test scenarios presented by the map test cases. The map simulation tester 120 may evaluate the AV compute process 112 in navigating through each of the plurality of paths corresponding to each of the map test cases to provide the map test results 420. In one aspect, the map test results 420 may indicate a passing rate and/or a failing rate for the map under test as shown in FIG. 4B. In another aspect, the map test results 420 may indicate a more detailed view of the failures as shown in FIG. 4C.

FIG. 4B illustrates a map simulation test result 430, according to some examples of the present disclosure. The map simulation test result 430 may correspond to a map test result output by the map simulation tester 120 in the scheme 400. As shown, the map test result 430 may include a pie chart with a percentage of map test cases with a failure result (shown as test fail 432) and a percentage of map test cases with a pass result (show as test pass 434). In this regard, the test fail 432 may correspond to the percentage of map test cases in which the AV compute process 112 fails to navigate through respective paths in the map test cases, and the test pass 434 may correspond to the percentage of map test cases in which the AV compute process 112 successfully navigating through respective paths in the map test cases. In general, the test result 430 may indicates the test fail 432 and the test pass 434 in any suitable forms, such as bar graphs, texts or printouts, etc.

FIG. 4C illustrates a map simulation test result 440, according to some examples of the present disclosure. The map simulation test result 440 may correspond to a map test result output by the map simulation tester 120 in the scheme 400. For instance, the map simulation tester 120 may analyze the map test cases in which the AV compute process 112 failed and categorize the reasons of the failures into various groups. As shown, the map test result 440 may include a pie chart with a percentage of map test cases with a failure result due to a fail code A (shown by 442), a percentage of map test cases with a failure result due to a fail code B (shown by 444), and a percentage of map test cases with a failure result due to a fail code C (shown by 446). As an example, the failures with the failure code A may be due to a map error, the failures with the failure code B may be due to an AV planning error, and the failures with the failure code C may be due to a simulator or runtime error. In general, the map simulation tester 120 may categorize the failed map test cases into any suitable categories and/or any suitable number of categories (e.g., 2, 3, 4, 5, 6 or more).

In some further aspects, the map test configuration 410 may include configuration parameters for map testing. For instance, the map test configuration 410 may indicate an operation mode of the AV compute process 112, where the mode may be associated with a capability, a traffic rule, and/or an expected response time or run time. As an example, the map test configuration 410 may indicate that the AV compute process 112 is capable of making an unprotected left-turn, driving at a certain speed, or respond to a scenario within a certain response time, etc. In some examples, the map test configuration 410 may indicate the capability using a capability flag (e.g., enabled or disabled) or multiple capability bits, each indicating a different one of a plurality of capabilities of the AV compute process 112. Additionally or alternatively, the map test configuration 410 may include traffic rule(s) or a certain ODD. As an example, the map test configuration 410 may indicate that a right turn on red traffic light and/or a maximum traffic speed of 80 miles per hour are permitted in the ODD, etc. In some examples, the map test configuration 410 may indicate the traffic rule(s) using a traffic rule flag (e.g., enabled or disabled) or multiple traffic rule bits, each indicating a different one of a plurality of traffic rules under the ODD. Additionally or alternatively, the map test configuration 410 may include an indication of a target response time of the AV compute process 112. That is, a map test case may be considered as a failed test case if the AV compute process 112 fails to navigate through a respective path in the map test cases within the target response time.

In general, the map test configuration 410 may indicate any suitable combinations of geofence, number of map test cases, number of traffic links (e.g., streets, lanes, groups of streets, groups of lanes) to be covered by the map test cases, and/or configurability (e.g., AV capabilities, traffic rules, target performance, etc.). In some examples, AV capabilities may include maneuvers such as minor and/or major unprotected right-hand turns, turning on red lights, U-turns, traffic circles, and/or new constraints. As an example, a new constraint may be due to a change in the legal speed limit for a certain road, for example, extending from 25 mph to 45 mph. Further, the geofence indicated by the map test configuration 410 can be configurable, for example, expand to include a larger area or shrink to include a smaller area based on the type of map tests and/or the scope of the map tests (e.g., for short-term map update, long-term map update, map data integration, minor release, major release, etc.). The map simulation tester 120 may consider the constraints and/or configuration parameters indicated by the map test configuration 410 to sample the traffic links (e.g., including roads and/or lanes) on the map and generate map simulation and test cases accordingly.

In some aspects, the map simulation tester 120 may receive a request for testing a certain AV compute process 112 against a certain map and may receive the map test configuration 410 as part of the request. In an example, the request may be sent by an AV stack developer and the request may be for testing the performance of an AV stack during a development stage or prior to a code merge. In another example, the request may be sent by a code integration engineer and the request may be for testing the performance of an AV stack during an integration stage. In yet other examples, the request may be sent by a code release engineer and the request may be for testing the performance of an AV stack during a release stage. In yet another example, the request may be sent by a map engineer and the request may be for testing the performance of a map prior to a map update and/or release.

In general, the map testing mechanisms and associated testing for AV planning discussed above with reference to FIGS. 1-3 and 4A-4C 4 can be applied during any stage of an AV code development, integration, and release cycle and/or map generation, update, and/or release cycle.

In some further aspects, the map simulation tester 120 may receive a request for generating a map test object. The request may include a map test configuration similar to the map test configuration 410 discussed above. However, instead of testing the AV compute process 112 against the generated map test cases, the map simulation tester 120 may output a map test object (e.g., a data structure or database) including all the generated map test cases. The map test object can be stored and can be loaded into a simulator for map testing at any suitable time.

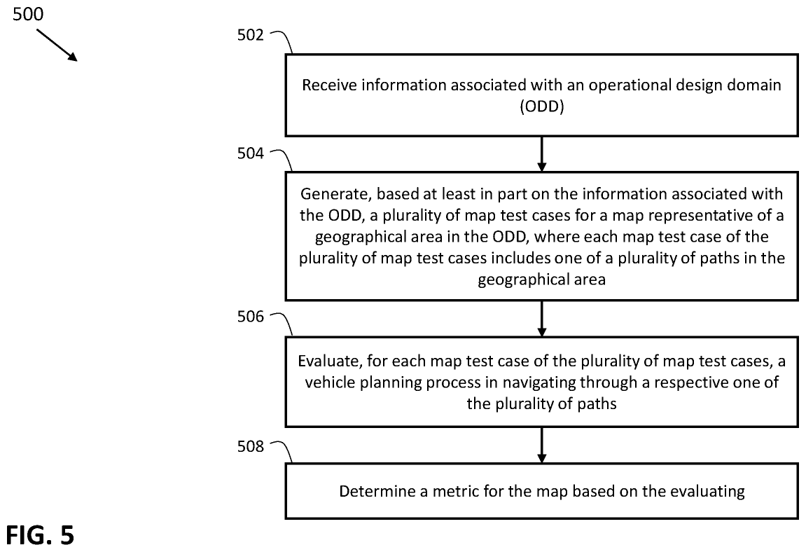

FIG. 5 illustrates a map simulation test process 500, according to some examples of the present disclosure. The process 500 can be implemented by a computer-implemented system such as the simulation platform 110 of FIG. 1, the simulation platform 756 of FIG. 7, and/or the processor-based system 800 of FIG. 8. In certain aspects, the process 500 can be implemented by the may simulation tester 120 of FIG. 1 and/or the map simulation service 832 of FIG. 8. In general, the process 500 may be performed using any suitable hardware components and/or software components. The process 500 may utilize similar mechanisms discussed above with reference to FIGS. 1-3 and 4A-4C. Operations are illustrated once each and in a particular order in FIG. 5, but the operations may be performed in parallel, reordered, and/or repeated as desired.

At 502, information associated with an ODD is received. The ODD information (e.g., the ODD information 140) may include an indication of one or more avoidance areas (e.g., the avoidance areas 108 and/or 240) in a geographical area within the ODD. The one or more avoidances areas can include long-term avoidance area(s) (e.g., to be avoided in the next 1-7 days or longer) and/or short-term avoidance area(s) (e.g., to be avoided in the next 1-4 hours or shorter). In some aspects, the ODD information are real-time information received by the computer-implemented system in real-time or near real-time. In other words, the ODD information may be received upon at the time when the ODD information is applied.

At 504, a plurality of map test cases (e.g., the map test cases 122) for a map representative of a geographical area in the ODD are generated based at least in part on the information associated with the ODD. For instance, each map test case of the plurality of map test cases may include one of a plurality of paths (e.g., the paths 222, 224, 226, 228, 230) in the geographical area. As part of generating the plurality of map test cases, the computer-implemented system may determine the plurality of paths in a portion of the geographical area outside of the one or more avoidance areas. In some aspects, the computer-implemented system may iterate through a plurality of traffic links (e.g., the traffic links 212, 214, 216, 320) in the geographical area to determine the plurality of paths, where the iterating may include filtering out one or more un-routable traffic links (e.g., within the one or more avoidance areas or in a blacklist provided by the ODD information) in the geographical area, for example, as discussed above with reference to FIG. 2. In some aspects, the plurality of traffic links through which the computer-implemented system iterated to determine the plurality of paths may have a granularity of a street, a lane, a group of streets, or a group of lanes. In some aspects, the plurality of traffic links through which the computer-implemented system iterated to determine the plurality of paths may be within a geofence (e.g., the geofence 106 of FIG. 1) in the geographical area. In some aspects, as part of generating the plurality of map test cases, the computer-implemented system may generate a plurality of subgraphs, for example, as discussed above with reference to FIG. 3. Each subgraph may be representative of a traffic link segment (e.g., a street segment or a lane segment) in the geographical area. The computer-implemented system may determine a first path of the plurality of paths by selecting one or more connected subgraphs from the plurality of subgraphs. In some aspects, the selecting of the one or more connected subgraphs may be further based on a second subgraph of the plurality of subgraphs, the second subgraph connecting to a start or an end of the one or more connected subgraphs.

At 506, for each map test case, a vehicle planning process (e.g., the vehicle compute process 112, software code, firmware code) in navigating through a respective one of the plurality of paths may be evaluated. For instance, the vehicle planning process may be executed in a simulator configured with a traffic scenario as specified by each map test case, and the performance of the vehicle planning process will be evaluated (e.g., whether the vehicle planning process successfully navigate through a respective path). In some aspects, the evaluation of the vehicle planning process in navigating through the one or more plurality of paths used for determining the metric for the map may be based on a vehicle capability (e.g., making an unprotected left-turn, driving at a certain speed, or respond to a scenario within a certain response time, etc.). In some aspects, the evaluation of the vehicle planning process in navigating through the one or more plurality of paths used for determining the metric for the map may be based a traffic rule (e.g., making a right-turn on red, a maximum travel speed, a minimum travel speed, etc.). In some aspects, the evaluation of the vehicle planning process in navigating through the one or more plurality of paths used for determining the metric for the map may be based on a target vehicle performance (e.g., a response time in navigating through the respective path).

At 508, a metric for the map may be determined based on the evaluation of the vehicle planning process at 506. In some aspects, the metric may include at least one of a passing rate or a failing rate, for example, as discussed above with reference to FIG. 4B. A passing rate may be a percentage of the map test cases in which the vehicle compute process successfully navigated through the respective paths. A failing rate may be a percentage of the map test cases in which the vehicle compute process fails to navigate through the respective paths. Alternatively, the pass/fail metric may be in terms of a number of passed map test cases and/or a number of failed map test cases. In some aspects, the metric may categorize the failed map test cases according to the error codes or failure codes indicating the reasons of the failures, for example, as discussed above with reference to FIG. 4C.

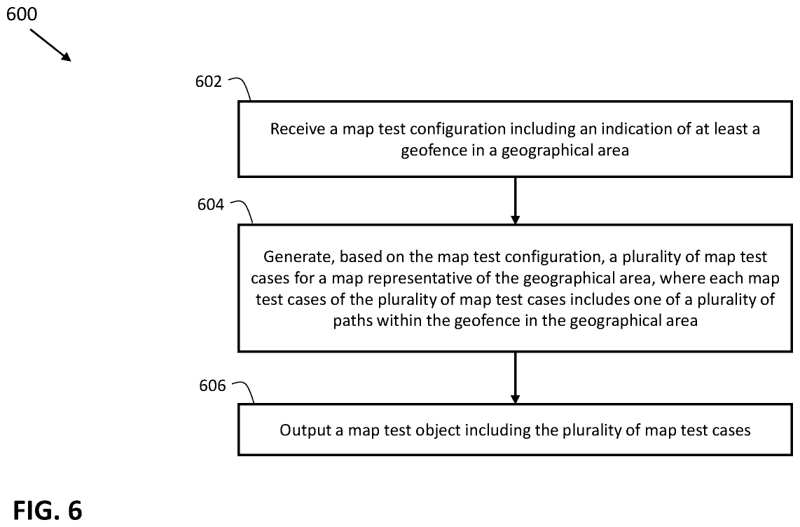

FIG. 6 illustrates a map simulation test process 600, according to some examples of the present disclosure. The process 600 can be implemented by a computer-implemented system such as the simulation platform 110 of FIG. 1, the simulation platform 756 of FIG. 7, and/or the processor-based system 800 of FIG. 8. In certain aspects, the process 600 can be implemented by the map simulation tester 120 of FIG. 1, the map simulation tester 757 of FIG. 7, and/or the map simulation test service 832 of FIG. 8. In general, the process 600 may be performed using any suitable hardware components and/or software components. The process 600 may utilize similar mechanisms discussed above with reference to FIGS. 1-3, 4A-4C, and 5. Operations are illustrated once each and in a particular order in FIG. 6, but the operations may be performed in parallel, reordered, and/or repeated as desired.

At 602, a map test configuration including an indication of at least a geofence in a geographical area is received. Additionally or alternatively, the map test configuration may include an indication of a number of map test cases to be generated for testing. Additionally or alternatively, the map test configuration may include an indication of a number of traffic links (e.g., including streets and/or lanes) within the geofence in the geographical area is to be covered for testing. In some aspects, the map test configuration may be similar to the map test configuration 410 discussed above with reference to FIG. 4.

At 604, a plurality of map test cases (e.g., the map cases 122) for a map representative of the geographical area is generated based on the map test configuration. Each map test case of the plurality of map test cases may include one of a plurality of paths (e.g., the paths 222, 224, 226, 228, 230) within the geofence in the geographical area. In some aspects, as part of generating the plurality of map test cases, the computer-implemented system may iterate through at least one of a plurality of streets or a plurality of lanes (e.g., the traffic links 212, 214, 216, 320) within the geofence in the geographical area to determine the plurality of paths as discussed above with reference to FIGS. 1-3, 4A-4B, and 5. The computer-implemented system may further filter out the at least one of an un-routable street or an un-routable lane, for example, in one or more avoidance areas indicated by ODD information (e.g., the ODD information 140).

At 606, a map test object including the plurality of map test cases is output. The map test object may be stored in a data structure or database including all the generated map test cases in any suitable format. The map test object can be stored and loaded into a simulator (e.g., the simulation platform 110 of FIG. 1 or the simulation platform 756 of FIG. 7) for map testing and/or AV planning stack testing at any suitable time.

In some aspects, the process 600 may further include receiving a request to modify the geofence indicated by the map test configuration. Accordingly, the computer-implemented system may generate a second plurality of map test cases, each including one of a second plurality of paths within the modified geofence in the geographical area.

Turning now to FIG. 7, this figure illustrates an example of an AV management system 700. One of ordinary skill in the art will understand that, for the AV management system 700 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 700 includes an AV 702, a data center 750, and a client computing device 770. The AV 702, the data center 750, and the client computing device 770 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 702 may navigate about roadways without a human driver based on sensor signals generated by multiple sensor systems 704, 706, and 708. The sensor systems 704-708 may include different types of sensors and may be arranged about the AV 702. For instance, the sensor systems 704-708 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 may be a camera system, the sensor system 706 may be a LIDAR system, and the sensor system 708 may be a RADAR system. Other embodiments may include any other number and type of sensors.

AV 702 may also include several mechanical systems that may be used to maneuver or operate AV 702. For instance, the mechanical systems may include vehicle propulsion system 730, braking system 732, steering system 734, safety system 736, and cabin system 738, among other systems. Vehicle propulsion system 730 may include an electric motor, an internal combustion engine, or both. The braking system 732 may include an engine brake, a wheel braking system (e.g., a disc braking system that utilizes brake pads), hydraulics, actuators, and/or any other suitable componentry configured to assist in decelerating AV 702. The steering system 734 may include suitable componentry configured to control the direction of movement of the AV 702 during navigation. Safety system 736 may include lights and signal indicators, a parking brake, airbags, and so forth. The cabin system 738 may include cabin temperature control systems, in-cabin entertainment systems, and so forth. In some embodiments, the AV 702 may not include human driver actuators (e.g., steering wheel, handbrake, foot brake pedal, foot accelerator pedal, turn signal lever, window wipers, etc.) for controlling the AV 702. Instead, the cabin system 738 may include one or more client interfaces (e.g., Graphical User Interfaces (GUIs), Voice User Interfaces (VUIs), etc.) for controlling certain aspects of the mechanical systems 730-738.

AV 702 may additionally include a local computing device 710 that is in communication with the sensor systems 704-708, the mechanical systems 730-738, the data center 750, and the client computing device 770, among other systems. The local computing device 710 may include one or more processors and memory, including instructions that may be executed by the one or more processors. The instructions may make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes a perception stack 712, a mapping and localization stack 714, a planning stack 716, a control stack 718, a communications stack 720, an HD geospatial database 722, and an AV operational database 724, among other stacks and systems.

Perception stack 712 may enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-708, the mapping and localization stack 714, the HD geospatial database 722, other components of the AV, and other data sources (e.g., the data center 750, the client computing device 770, third-party data sources, etc.). The perception stack 712 may detect and classify objects and determine their current and predicted locations, speeds, directions, and the like. In addition, the perception stack 712 may determine the free space around the AV 702 (e.g., to maintain a safe distance from other objects, change lanes, park the AV, etc.). The perception stack 712 may also identify environmental uncertainties, such as where to look for moving objects, flag areas that may be obscured or blocked from view, and so forth.

Mapping and localization stack 714 may determine the AV's position and orientation (pose) using different methods from multiple systems (e.g., GPS, IMUs, cameras, LIDAR, RADAR, ultrasonic sensors, the HD geospatial database 722, etc.). For example, in some embodiments, the AV 702 may compare sensor data captured in real-time by the sensor systems 704-708 to data in the HD geospatial database 722 to determine its precise (e.g., accurate to the order of a few centimeters or less) position and orientation. The AV 702 may focus its search based on sensor data from one or more first sensor systems (e.g., GPS) by matching sensor data from one or more second sensor systems (e.g., LIDAR). If the mapping and localization information from one system is unavailable, the AV 702 may use mapping and localization information from a redundant system and/or from remote data sources.

The planning stack 716 may determine how to maneuver or operate the AV 702 safely and efficiently in its environment. For example, the planning stack 716 may receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 702 from one point to another. The planning stack 716 may determine multiple sets of one or more mechanical operations that the AV 702 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 716 may select from multiple backup plans to carry out. For example, while preparing to change lanes to turn right at an intersection, another vehicle may aggressively cut into the destination lane, making the lane change unsafe. The planning stack 716 could have already determined an alternative plan for such an event, and upon its occurrence, help to direct the AV 702 to go around the block instead of blocking a current lane while waiting for an opening to change lanes.

The control stack 718 may manage the operation of the vehicle propulsion system 730, the braking system 732, the steering system 734, the safety system 736, and the cabin system 738. The control stack 718 may receive sensor signals from the sensor systems 704-708 as well as communicate with other stacks or components of the local computing device 710 or a remote system (e.g., the data center 750) to effectuate operation of the AV 702. For example, the control stack 718 may implement the final path or actions from the multiple paths or actions provided by the planning stack 716. Implementation may involve turning the routes and decisions from the planning stack 716 into commands for the actuators that control the AV's steering, throttle, brake, and drive unit.

The communication stack 720 may transmit and receive signals between the various stacks and other components of the AV 702 and between the AV 702, the data center 750, the client computing device 770, and other remote systems. The communication stack 720 may enable the local computing device 710 to exchange information remotely over a network, such as through an antenna array or interface that may provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 720 may also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 722 may store HD maps and related data of the streets upon which the AV 702 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 724 may store raw AV data generated by the sensor systems 704-708 and other components of the AV 702 and/or data received by the AV 702 from remote systems (e.g., the data center 750, the client computing device 770, etc.). In some embodiments, the raw AV data may include HD LIDAR point cloud data, image or video data, RADAR data, GPS data, and other sensor data that the data center 750 may use for creating or updating AV geospatial data as discussed further below with respect to FIG. 5 and elsewhere in the present disclosure.

The data center 750 may be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 750 may include one or more computing devices remote to the local computing device 710 for managing a fleet of AVs and AV-related services. For example, in addition to managing the AV 702, the data center 750 may also support a ridesharing service, a delivery service, a remote/roadside assistance service, street services (e.g., street mapping, street patrol, street cleaning, street metering, parking reservation, etc.), and the like.

The data center 750 may send and receive various signals to and from the AV 702 and the client computing device 770. These signals may include sensor data captured by the sensor systems 704-708, roadside assistance requests, software updates, ridesharing pick-up and drop-off instructions, and so forth. In this example, the data center 750 includes one or more of a data management platform 752, an Artificial Intelligence/Machine Learning (AI/ML) platform 754, a simulation platform 756, a remote assistance platform 758, a ridesharing platform 760, and a map management platform 762, among other systems.

Data management platform 752 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 750 may access data stored by the data management platform 752 to provide their respective services.

The AI/ML platform 754 may provide the infrastructure for training and evaluating machine learning algorithms for operating the AV 702, the simulation platform 756, the remote assistance platform 758, the ridesharing platform 760, the map management platform 762, and other platforms and systems. Using the AI/ML platform 754, data scientists may prepare data sets from the data management platform 752; select, design, and train machine learning models; evaluate, refine, and deploy the models; maintain, monitor, and retrain the models; and so on.

The simulation platform 756 may enable testing and validation of the algorithms, machine learning models, neural networks, and other development efforts for the AV 702, the remote assistance platform 758, the ridesharing platform 760, the map management platform 762, and other platforms and systems. The simulation platform 756 may replicate a variety of driving environments and/or reproduce real-world scenarios from data captured by the AV 702, including rendering geospatial information and road infrastructure (e.g., streets, lanes, crosswalks, traffic lights, stop signs, etc.) obtained from the map management platform 762; modeling the behavior of other vehicles, bicycles, pedestrians, and other dynamic elements; simulating inclement weather conditions, different traffic scenarios; and so on. In some embodiments, the simulation platform 756 may include a map simulation tester 757 (e.g., similar the map simulation tester 120) that generates map test cases for a map based on ODD information and/or map test configuration, evaluates a vehicle compute process or planning process against the map test cases, and determines a metric for the map as discussed herein.

The remote assistance platform 758 may generate and transmit instructions regarding the operation of the AV 702. For example, in response to an output of the AI/ML platform 754 or other system of the data center 750, the remote assistance platform 758 may prepare instructions for one or more stacks or other components of the AV 702.

The ridesharing platform 760 may interact with a customer of a ridesharing service via a ridesharing application 772 executing on the client computing device 770. The client computing device 770 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 772. The client computing device 770 may be a customer's mobile computing device or a computing device integrated with the AV 702 (e.g., the local computing device 710). The ridesharing platform 760 may receive requests to be picked up or dropped off from the ridesharing application 772 and dispatch the AV 702 for the trip.

Map management platform 762 may provide a set of tools for the manipulation and management of geographic and spatial (geospatial) and related attribute data. The data management platform 752 may receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data may be processed, and map management platform 762 may render base representations (e.g., tiles (2D), bounding volumes (3D), etc.) of the AV geospatial data to enable users to view, query, label, edit, and otherwise interact with the data. Map management platform 762 may manage workflows and tasks for operating on the AV geospatial data. Map management platform 762 may control access to the AV geospatial data, including granting or limiting access to the AV geospatial data based on user-based, role-based, group-based, task-based, and other attribute-based access control mechanisms. Map management platform 762 may provide version control for the AV geospatial data, such as to track specific changes that (human or machine) map editors have made to the data and to revert changes when necessary. Map management platform 762 may administer release management of the AV geospatial data, including distributing suitable iterations of the data to different users, computing devices, AVs, and other consumers of HD maps. Map management platform 762 may provide analytics regarding the AV geospatial data and related data, such as to generate insights relating to the throughput and quality of mapping tasks.

In some embodiments, the map viewing services of map management platform 762 may be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ridesharing platform 760 may incorporate the map viewing services into the client application 772 to enable passengers to view the AV 702 in transit enroute to a pick-up or drop-off location, and so on.

FIG. 8 illustrates an example processor-based system with which some aspects of the subject technology may be implemented. For example, processor-based system 800 may be any computing device making up, or any component thereof in which the components of the system are in communication with each other using connection 805. Connection 805 may be a physical connection via a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 may include a cache of high-speed memory 812 connected directly with, in close proximity to, or integrated as part of processor 810.

Processor 810 may include any general-purpose processor and a hardware service or software service, such as a map simulation test service 832 stored in storage device 830, configured to control processor 810 as well as a special-purpose processor where software instructions are incorporated into the actual processor design. The map simulation test service 832 may generate map test cases for a map based on ODD information and/or a map test configuration, evaluate a vehicle compute process or planning process against the map test cases, and/or determine a metric for the map as discussed herein. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms known to those of skill in the art. In some instances, multimodal systems may enable a user to provide multiple types of input/output to communicate with computing system 800. Computing system 800 may include communications interface 840, which may generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 may include software services, servers, services, etc., that when the code that defines such software is executed by the processor 810, it causes the system 800 to perform a function. In some embodiments, a hardware service that performs a particular function may include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 includes a computer-implemented system, including one or more non-transitory computer-readable media storing instructions, when executed by one or more processing units, cause the one or more processing units to perform operations including receiving, by a computer-implemented system, information associated with an operational design domain (ODD) (e.g., in which AVs are to operate); generating, by the computer-implemented system based at least in part on the information associated with the ODD, a plurality of map test cases for a map representative of a geographical area in the ODD, where each map test case of the plurality of map test cases includes one of a plurality of paths in the geographical area; and determining a metric for the map based on an evaluation of a vehicle planning process in navigating through one or more of the plurality of paths corresponding to one or more of the plurality of map test cases.

In Example 2, the computer-implemented system of Example 1 can optionally include where the information associated with the ODD includes an indication of one or more avoidance areas in the geographical area.

In Example 3, the computer-implemented system of any one of Examples 1-2 can optionally include where the generating the plurality of map test cases includes determining the plurality of paths in a portion of the geographical area outside of the one or more avoidance areas.

In Example 4, the computer-implemented system of any one of Examples 1-3 can optionally include where the information associated with the ODD includes real-time information indicating one or more avoidance areas in the geographical area.

In Example 5, the computer-implemented system any one of Examples 1-4 can optionally include where the generating the plurality of map test cases includes iterating through a plurality of traffic links in the geographical area to determine the plurality of paths, the iterating including filtering out one or more un-routable traffic links in the geographical area.

In Example 6, the computer-implemented system of any one of Examples 1-5 can optionally include where the plurality of traffic links has a granularity of a street, a lane, a group of streets, or a group of lanes.

In Example 7, the computer-implemented system of any one of Examples 1-6 can optionally include where the generating the plurality of map test cases is further based on a geofence in the geographical area.

In Example 8, the computer-implemented system of any one of Examples 1-7 can optionally include where the generating the plurality of map test cases includes generating a plurality of subgraphs, each representative of a street segment or a lane segment in the geographical area; and determine a first path of the plurality of paths by selecting one or more connected subgraphs from the plurality of subgraphs.

In Example 9, the computer-implemented system of any one of Examples 1-8 can optionally include where the selecting the one or more connected subgraphs is further based on a second subgraph of the plurality of subgraphs, the second subgraph connecting to a start or an end of the one or more connected subgraphs.

In Example 10, the computer-implemented system of any one of Examples 1-9 can optionally include where the operations further include evaluating, for a first map test case of the one or more of the plurality of map test cases, the vehicle planning process in navigating through a respective one of the plurality of paths.

In Example 11, the computer-implemented system of any one of Examples 1-10 can optionally include where the evaluation of the vehicle planning process in navigating through the one or more plurality of paths used for determining the metric for the map is based on a vehicle capability (e.g., maneuvers such as minor and/or major unprotected right-hand turns, turning on red lights, U-turns, traffic circles, and/or new constraints such as a legal speed limit change for a certain road).

In Example 12, the computer-implemented system of any one of Examples 1-11 can optionally include where the evaluation of the vehicle planning process in navigating through the one or more plurality of paths used for determining the metric for the map is based on a traffic rule.

In Example 13, the computer-implemented system of any one of Examples 1-12 can optionally include where the evaluation of the vehicle planning process in navigating through the one or more plurality of paths used for determining the metric for the map is based on an expected run time.

In Example 14, the computer-implemented system of any one of Examples 1-13 can optionally include where the determining the metric for the map includes determining at least one of a number of the plurality of map test cases in which the vehicle planning process successfully navigate or failed to navigate through respective paths of the plurality of paths.

Example 15 includes a method including receiving, by a computer-implemented system, a map test configuration including an indication of at least a geofence in a geographical area; generating, by the computer-implemented system based on the map test configuration, a plurality of map test cases for a map representative of the geographical area, where each map test case of the plurality of map test cases includes one of a plurality of paths within the geofence in the geographical area; and outputting a map test object including the plurality of map test cases.

In Example 16, the method of Example 15 can optionally include where the map test configuration for generating the plurality of map test cases further includes an indication of a number of map test cases.

In Example 17, the method of any one of Examples 15-16 can optionally include where the map test configuration for generating the plurality of map test cases further includes an indication of at least one of a number of streets or a number of lanes within the geofence in the geographical area to be covered by the plurality of map test cases.

In Example 18, the method of any one of Examples 15-17 can optionally include where the generating the plurality of map test cases includes iterating through at least one of a plurality of streets or a plurality of lanes within the geofence in the geographical area to determine the plurality of paths.

In Example 19, the method of any one of Examples 15-18 can optionally include where the iterating through the at least one of the plurality of streets or the plurality of lanes including filtering out at least one of an un-routable street or an un-routable lane within the geofence in the geographical area.

In Example 20, the method of any one of Examples 15-19 can optionally include where the filtering out the at least one of the un-routable street or the un-routable lane is based on one or more operation design domain (ODD) avoidance areas.

In Example 21, the method of any one of Examples 15-20 can optionally include determining, for each map test cases of the plurality of map test cases, whether a vehicle compute process passes or fails in navigating through a respective one of the plurality of paths; and computing, based on the determining, a statistical performance of the vehicle compute process.

In Example 22, the method of any one of Examples 15-21 can optionally include where the statistical performance of the vehicle compute process includes at least one of a pass rate or a fail rate.

In Example 23, the method of any one of Examples 15-22 can optionally include where the statistical performance of the vehicle compute process includes at least a first fail rate associated with a first fail code and a second fail rate associated with a second fail code.

In Example 24, the method of any one of Examples 15-16 can optionally include receiving, by the computer-implemented system, a request to modify the geofence; and generating, by the computer-implemented system, a second plurality of map test cases, each including one of a second plurality of paths within the modified geofence in the geographical area.

Example 25 includes a method including receiving, by a computer-implemented system, information associated with an operational design domain (ODD); generating, by the computer-implemented system based at least in part on the information associated with the ODD, a plurality of map test cases for a map representative of a geographical area in the ODD, where each map test case of the plurality of map test cases includes one of a plurality of paths in the geographical area; evaluating a vehicle planning process in navigating through one or more of the plurality of paths corresponding to one or more of the plurality of map test cases; and determining a metric for the map based on the evaluating.

In Example 26, the method of Example 25 can optionally include where the information associated with the ODD includes an indication of one or more avoidance areas in the geographical area; and the generating the plurality of map test cases includes excluding the one or more avoidance areas for all of the plurality of paths.

In Example 27, the method of any one of Examples 25-26 can optionally include where the generating the plurality of map test cases includes iterating through a plurality of traffic links in the geographical area to determine the plurality of paths, the iterating including filtering out one or more un-routable traffic links in the geographical area, the plurality of traffic links including at least one of one or more streets or one or more lanes in the geographical area.

Example 28 includes an apparatus comprising means for performing the method of any of the Examples 15-24.

Example 29 includes an apparatus comprising means for performing the method of any of the Examples 25-27.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented system, comprising:
one or more non-transitory computer-readable media storing instructions, when executed by one or more processing units, cause the one or more processing units to perform operations comprising:
receiving, by a computer-implemented system, information associated with an operational design domain (ODD);
generating, by the computer-implemented system based at least in part on the information associated with the ODD, a plurality of map test cases for a map representative of a geographical area in the ODD, wherein each map test case of the plurality of map test cases includes one of a plurality of paths in the geographical area; and
determining a metric for the map based on an evaluation of a vehicle planning process in navigating through one or more of the plurality of paths corresponding to one or more of the plurality of map test cases.

2. The computer-implemented system of claim 1, wherein the information associated with the ODD comprises an indication of one or more avoidance areas in the geographical area.

3. The computer-implemented system of claim 2, wherein the generating the plurality of map test cases comprises:
determining the plurality of paths in a portion of the geographical area outside of the one or more avoidance areas.

4. The computer-implemented system of claim 1, wherein the generating the plurality of map test cases comprises:
iterating through a plurality of traffic links in the geographical area to determine the plurality of paths, the iterating comprising filtering out one or more un-routable traffic links in the geographical area.

5. The computer-implemented system of claim 4, wherein the plurality of traffic links has a granularity of a street, a lane, a group of streets, or a group of lanes.

6. The computer-implemented system of claim 1, wherein the generating the plurality of map test cases is further based on a geofence in the geographical area.

7. The computer-implemented system of claim 1, wherein the generating the plurality of map test cases comprises:
generating a graph representative of a traffic link in the geographical area, wherein the graph includes a plurality of subgraphs, each representative of a segment of the traffic link; and
determining a first path of the plurality of paths by selecting one or more connected subgraphs from the plurality of subgraphs.

8. The computer-implemented system of claim 7, wherein the selecting the one or more connected subgraphs is further based on a second subgraph of the plurality of subgraphs, the second subgraph connecting to a start or an end of the one or more connected subgraphs.

9. The computer-implemented system of claim 1, wherein the operations further comprise:
evaluating, for a first map test case of the one or more of the plurality of map test cases, the vehicle planning process in navigating through a respective one of the plurality of paths.

10. The computer-implemented system of claim 1, wherein the evaluation of the vehicle planning process in navigating through the one or more plurality of paths used for determining the metric for the map is based on a mode of the vehicle, the mode associated with at least one of a vehicle capability, a traffic rule, or an expected run time.

11. The computer-implemented system of claim 1, wherein the determining the metric for the map comprises:
determining at least one of a number of the plurality of map test cases in which the vehicle planning process successfully navigate or failed to navigate through respective paths of the plurality of paths.

12. A method comprising:
receiving, by a computer-implemented system, a map test configuration including an indication of at least a geofence in a geographical area;
generating, by the computer-implemented system based on the map test configuration, a plurality of map test cases for a map representative of the geographical area, wherein each map test case of the plurality of map test cases includes one of a plurality of paths within the geofence in the geographical area; and
outputting a map test object including the plurality of map test cases.

13. The method of claim 12, wherein the map test configuration for generating the plurality of map test cases further includes an indication of a number of map test cases.

14. The method of claim 12, wherein the map test configuration for generating the plurality of map test cases further includes an indication of at least one of a number of streets or a number of lanes within the geofence in the geographical area to be covered by the plurality of map test cases.

15. The method of claim 12, wherein the generating the plurality of map test cases comprises:
iterating through at least one of a plurality of streets or a plurality of lanes within the geofence in the geographical area to determine the plurality of paths.

16. The method of claim 15, wherein the iterating through the at least one of the plurality of streets or the plurality of lanes comprising:
filtering out at least one of an un-routable street or an un-routable lane within the geofence in the geographical area.

17. The method of claim 12, further comprising:
determining, for each map test cases of the plurality of map test cases, whether a vehicle compute process passes or fails in navigating through a respective one of the plurality of paths; and
computing, based on the determining, a statistical performance of the vehicle compute process.

18. A method comprising:
receiving, by a computer-implemented system, information associated with an operational design domain (ODD);
generating, by the computer-implemented system based at least in part on the information associated with the ODD, a plurality of map test cases for a map representative of a geographical area in the ODD, wherein each map test case of the plurality of map test cases includes one of a plurality of paths in the geographical area;
evaluating a vehicle planning process in navigating through one or more of the plurality of paths corresponding to one or more of the plurality of map test cases; and
determining a metric for the map based on the evaluating.

19. The method of claim 18, wherein:
the information associated with the ODD comprises an indication of one or more avoidance areas in the geographical area; and
the generating the plurality of map test cases comprises:
excluding the one or more avoidance areas for all of the plurality of paths.

20. The method of claim 18, wherein the generating the plurality of map test cases comprises:
iterating through a plurality of traffic links in the geographical area to determine the plurality of paths, the iterating comprising filtering out one or more un-routable traffic links in the geographical area, the plurality of traffic links including at least one of one or more streets or one or more lanes in the geographical area.
